(19) United States
(12) Patent Application Publication
(10) Pub. No.: US 2005/0053910 A1
(43) Pub. Date: Mar. 10, 2005

(54) Gene transfer composition and method

(76) Inventors: Ian McKenzie, Victoria (AU); Mauro Sandrin, Victoria (AU); Nicole Webster, Brunswick (AU); Marialuisa Lavitrano, Brunswick Victoria (AU)

Correspondence Address: SHERIDAN ROSS PC, 1560 BROADWAY, SUITE 1200, DENVER, CO, 80202, US

(21) Appl. No.: 10/491,580

(22) PCT Filed: Oct. 2, 2002
(86) PCT No.: PCT/AU02/01344

(30) Foreign Application Priority Data
Oct. 2, 2001 (AU) PR 8035

(51) Int. Cl. A01N 1/02

(52) U.S. Cl. 435/2

(57) ABSTRACT

The invention relates to cell culture media more particularly to fertilisation media, to making and using transgenes, to providing sperm cells for fertilisation particularly in applications such as sperm-mediated gene transfer and to using sperm cells for generating transgenic animals.

### FIELD OF THE INVENTION

The invention relates to cell culture media more particularly to fertilisation media, to making and using transgenes, to providing sperm cells for fertilisation particularly in applications such as sperm-mediated gene transfer and to using sperm cells for generating transgenic animals.

### BACKGROUND OF THE INVENTION

Selective animal breeding is a conventional approach for genotype modification or improvement. The objective of selective breeding is to increase the frequency of desirable traits and to decrease the frequency of less desirable traits in a population. As this approach to genotype modification is based on the selection of existing genes rather than on the creation of new genes, it is both time consuming and costly. Further, as new genes are not created by selective breeding, there is a limitation as to the diversity of phenotypes that can be produced by selective animal breeding.

Transgenesis is a more recent approach to genotype modification. Transgenesis is a process by which a nucleic acid molecule, such as a gene, that is exogenous, or in other words, foreign to an animal, is introduced into a genome so that the nucleic acid molecule integrates into the germ line of the animal and is inherited in a Mendelian manner. An exogenous or foreign nucleic acid molecule that integrates into the germ line is known as a “transgene”. As genotype modification is based on the creation of new genes, one consequence of transgenesis is that both the time and cost for achieving a desirable trait in a population are reduced. However, more importantly, the diversity of phenotypes that can be achieved by transgenesis is far greater than the diversity that is achieved by selective animal breeding. This means that animals can be generated comprising one or more traits that are not common to the species from which the animal is derived. For example, a non human animal can be generated that contains one or more human traits. This has obvious implications for the uses to which such animals may be put.

To date, the production of transgenic animals has relied almost exclusively on pronuclear microinjection, whereby an exogenous nucleic acid molecule for use as a transgene is physically microinjected into pronuclei of a fertilized ovum. While the technique has been used successfully to generate transgenic animals in a wide variety of species, the technique has poor efficiency for generating transgenic animals in species other than mice. More particularly, the frequency of farm animals, such as cattle and pigs, that contain a germ line modification as a result of pronuclear microinjection is about 0.5 to 4% [Niemann et al. 2000 Anim. Reprod. Sci. 60-61, 277-293]. It has been suggested that the low efficiency of pronuclear microinjection in animals other than mice is attributable to factors such as low transgene integration rates, unpredictable transgene behaviour and high mortality rate of manipulated ova [Horan et al. 1991 Arch. Androl 26:83-92; Wall 2002 Theriogenology 57:189-201].

Sperm-mediated gene transfer (SMGT) is one of a number of alternative approaches for the generation of transgenic animals [Lavitrano et al. 1989 Cell 57:717-723; Wall et al. 2002 Theriogenology 57:189-201]. According to this approach, an exogenous nucleic acid molecule for use as a transgene is introduced into a sperm cell to transfect the sperm cell, and the transfected sperm cell is then used as a vector to deliver the exogenous nucleic acid molecule to an ovum to provide a transgenic animal. Some key advantages of SMGT over other transgenic approaches are that SMGT does not require expensive equipment such as micro-injectors or micro-manipulators and specialist technical manipulation such as superovulation and collection and injection of zygotes is not required. According to the SMGT technique, transfected sperm can be used as a vector to deliver an exogenous nucleic acid molecule for use as a transgene to an ovum using standard artificial insemination procedures or by using standard in vitro fertilization procedures.

While SMGT has been used to generate transgenic animals in a wide variety of species, in some species such as pig, the efficiency of transgenesis has been poor. For example when applied to pigs, the frequency of offspring in which an exogenous nucleic acid molecule could be detected was about 5% [Sperandio et al. 1996 Animal Biotech 7:58-77]. None of these animals were demonstrated to contain a transgene; i.e. none of these animals were demonstrated to contain a germ line integration of an exogenous nucleic acid molecule. Accordingly, the efficiency of SMGT for production of transgenic pigs is equivalent to that of other techniques such as pronuclear microinjection. This means that SMGT has not yet been demonstrated to provide an improved efficiency over other techniques for producing transgenic pigs.

It has been proposed that the sequence of an exogenous nucleic acid molecule for use as a transgene affects the efficiency of SMGT for production of transgenic animals such as pigs and cattle [Sperandio et al. 1996 Animal Biotech. 7:58-77]. The objective of the study of Sperandio et al. 1996 was to adopt SMGT protocols originally developed for murine epididymal cells to use with ejaculated bovine and swine sperm cells. The study found that exogenous nucleic acid molecules for use as transgenes were substantially modified, most likely by rearrangement.

There is confusion as to the influence of sperm motility on the efficiency of SMGT. While a first study showed a relationship between the motility of bovine sperm cells and an ability of the cells to associate DNA, no evidence of sperm cell transfection was observed [Castro et al. 1991 Theriogenology 34:1099-1110]. A later study observed that both motile and damaged, immotile sperm are capable of binding a nucleic acid molecule to the sperm plasma membrane [Atkinson et al. 1991 Mol. Reprod. And Develop. 29:1-5]. In another study, no rigid conclusion could be drawn as to the relationship between sperm motility and binding of a sperm cell to a nucleic acid molecule [Horan et al. 1991 Arch. Androl 26:83-92].

In many circumstances the “ultimate” transgenic animal that is desired is one that comprises a number of traits that are not inherent in the species from which the animal is derived. For example, as it is believed that many gene products are involved in xenograft rejection, there is a need to generate a pig comprising tissues that express certain human antigens and that do not express certain pig antigens. In such circumstances, it is particularly important that transgenic animals are made available in significant numbers for use as founders for providing the multiple germ line modifications required for the generation of the ultimate animal. One way of providing significant numbers of transgenic animals for use as founders is to increase the numbers of animals for use in a transgenic program for generating founders. This would increase the time and cost of such programs.

Optimisation of the efficiency of SMGT would be a better approach. With optimised efficiency, the frequency of transgenic animals in progeny would be increased and accordingly, more transgenic animals would be made available for use as founders to provide the multiple germ line modifications required for generation of an ultimate animal comprising the desired genotype. Accordingly, an advantage of optimised efficiency of SMGT would be that an ultimate transgenic animal comprising the desired genotype would be generated more rapidly and with less expense.

### SUMMARY OF THE INVENTION

The invention seeks to optimise the efficiency of SMGT for producing a transgenic animal. In a first aspect, the invention provides a medium for supporting the viability of a sperm cell. The medium comprises, in water, glucose in a concentration of about 56 to 69 mM, sodium citrate in a concentration of about 31 to 37 mM, EDTA in a concentration of about 11 to 14 mM, citric acid in a concentration of about 14 to 17 mM and Trizma base in a concentration of about 48 to 59 mM. Typically the medium has an osmolarity of from about 200 to 320 mOs. Typically the medium has a pH of about 7.4.

The inventors have sought to improve the efficiency of SMGT for producing transgenic animals, especially for producing transgenic pigs. The inventors have found that the constitution of the medium in which sperm cells are processed during the SMGT procedure is particularly important for improving the frequency of embryos comprising an exogenous nucleic acid molecule for use as a transgene. They have also found that the medium is particularly important for improving the efficiency of SMGT for producing transgenic animals.

It is surprising that a medium according to the first aspect is capable of improving the efficiency of SMGT because the components of this medium are unlike those in conventional fertilisation medium, such as TALP [Ball et al. 1983 Biol. Reprod. 28:717-725] and FM [Whittingham 1971 J. Reprod. Fert. Suppl. 14:7-21], some of which have been used for SMGT [Sperandio et al. 1996 Animal Biotech. 7:58-77]. As described herein, when the medium of the invention is used in SMGT for generating transgenic embryos, the frequency of embryos comprising an exogenous nucleic acid molecule for use as a transgene is routinely observed to be 100%. In view of this improved frequency, one would anticipate an improved frequency of transgenic individuals. Indeed, in experiments described herein, the frequency of transgenic animals is observed to be in the range of 50 to 60%.

In a second aspect, the invention provides a process for the production of a medium for supporting the viability of a sperm cell comprising contacting glucose in an amount of about 10.1 to 12.4 g, sodium citrate (2H₂O) in an amount of about 9.0 to 11.0 g, EDTA (2H₂O) in an amount of about 4.2 to 5.2 g, citric acid (H₂O) in an amount of about 2.9 to 3.6 g and Trizina base in an amount of about 5.9 to 7.2 g, with about 1 litre of water, to form a solution with a pH of about pH7.4 and an osmolarity ranging from about 200 to 320 mOs.

In a third aspect, the invention provides a medium for supporting the viability of a sperm cell. The medium is produced by the process according to the second aspect of the invention.

In a fourth aspect, the invention provides a composition for providing a medium for supporting the viability of a sperm cell. The composition comprises glucose, sodium citrate, citric acid, EDTA and Trizma base in amounts sufficient for providing an aqueous solution having a concentration of glucose of from about 56 to 69 mM, a concentration of sodium citrate of from about 31 to 37 mM, a concentration of EDTA of from about 11 to 14 mM, a concentration of citric acid of from about 14 to 17 mM and a concentration of Trizma base of from about 48 to 59 mM.

In another aspect, the invention provides a method for collecting sperm cells from an animal for use in sperm-mediated gene transfer. The method comprises contacting a sample of semen derived from the animal with a medium according to the first aspect of the invention, to dilute the sample of semen.

In a fifth aspect, the invention provides a method for preparing a sperm cell for use in sperm-mediated gene transfer. The method comprises washing a sperm cell in a medium according to the first aspect of the invention, to remove seminal fluid from the sperm cell. The sperm cell is washed in conditions for supporting the viability of the sperm cell.

In a sixth aspect, the invention provides a method for transfecting a sperm cell with a nucleic acid molecule. The method comprising contacting the sperm cell with the nucleic acid molecule in a medium according to the first aspect of the invention. The sperm cell is contacted with the nucleic acid molecule in conditions for supporting the viability of the sperm cell.

In a seventh aspect, the invention provides a sperm cell transfected according to the method of the sixth aspect of the invention.

In an eighth aspect, the invention provides a cell, tissue or non-human animal prepared by fertilisation of an ovum with a sperm cell according to the seventh aspect of the invention.

The inventors have also found a direct relationship between sperm cell motility and the capacity of sperm cells to uptake a nucleic acid molecule. As described herein, the inventors have found that where the % of motile sperm cells in a sample is less than about 65-70%, the % of sperm cells in the sample that uptake a nucleic acid molecule is about 33% or less. Further, twice the number of sperm cells uptake a nucleic acid molecule in a sample in which 70% or more of sperm are motile sperm, as compared with a sample in which less than 65% of sperm are motile. This finding has important implications for the efficiency of SMGT for transgenesis.

Thus, in another aspect, the invention provides a method for determining whether a sample of sperm cells is optimal for transfection. The method comprises determining whether at least about 65% of the sperm cells in the sample are motile.

In another aspect, the invention provides a method for selecting a sample of sperm cells for transfection. The method comprises:
(a) determining the motility of sperm cells in a sample; and
(b) selecting a sample in which the motility of sperm cells is determined to be at least about 65%.

In another aspect, the invention provides a method for determining whether a sample of sperm cells are optimal for introducing a transgene into an oocyte. The method comprises determining whether at least about 65% of sperm cells in the sample are motile.

In another aspect, the invention provides a method for selecting a sample of sperm cells that are optimised for introducing a transgene into an oocyte. The method comprises:
(a) determining the motility of sperm cells in a sample; and
(b) selecting a sample in which the motility of sperm cells is determined to be at least about 65%.

As described above, the inventors have sought to improve the efficiency of SMGT for the purpose of increasing the availability of trangenic animals for use as founders for breeding an “ultimate” animal comprising a desired genotype. The advantages of this approach include minimisation of time and expenditure for obtaining the desired genotype. The inventors have also found that these advantages can be obtained by using SMGT to produce as a founder, an animal that contains more than one type of transgene.

More specifically, the inventors have found that any one sperm cell can be transfected with more than one type of exogenous nucleic acid molecule and that each exogenous nucleic acid molecule can then be transferred to an ovum by the transfected sperm cell according to SMGT to provide a transgenic embryo, from which will develop an individual comprising more than one type of transgene. In experiments described herein, the inventors have transfected sperm cells with a cocktail of exogenous nucleic acid molecules and have observed that all embryos derived from fertilization of ova with these sperm cells comprise the gene products of each exogenous nucleic acid molecule. The finding is surprising because previous studies have shown that transgenes are typically rearranged after integration and accordingly, are probably unable to express the desired gene product [Sperandio et al. 1996 Animal Biotech. 7:58-77]. The finding is of significance because it means that many of the intercrosses of particular founders are not required to arrive at an “ultimate” animal comprising the desired genotype.

Thus, in another aspect, the invention provides a method of producing a non-human animal comprising two or more transgenes. The method comprises the following steps:
(a) contacting a sperm cell with two or more exogenous nucleic acid molecules, each for use as a transgene, to transfect the sperm cell with each of the two or more exogenous nucleic acid molecules;
(b) fertilising an ovum with the transfected sperm cell to permit each of the two or more exogenous nucleic acid molecules to be transferred to the ovum; and
(c) maintaining the fertilised ovum in conditions for permitting the fertilised ovum to form the animal.

### BRIEF DESCRIPTION OF THE DRAWINGS

FIG. 1 shows the time course of uptake of linear ³H-deoxy-cytidine labelled EBFP (enhanced blue fluorescent protein) plasmid DNA by pig sperm from 5 boars;

FIG. 2 (i) a blastocyst expressing the three colours (a) blue, (b) green and (c) red, using filters specific for detection of each fluorescent protein; (d): white light microscope picture of the blastocyst (×75 magnification) and (e): composite picture of colour expression in all three filters. (ii) shows a negative control i.e. an example of a blastocyst which does not express any of the three colours: (a) white light microscope picture of the blastocyst at low power (×10); (b), (c) and (d): show lack of expression of colour in the blue, green and red filters respectively, (e): composite picture showing lack of colour expression in all three filters.

FIG. 3 shows the same blastocyst as in FIG. 2 but without the superimposing of the 3 colours: (i)(a): white light microscope picture of the blastocyst (×75 magnification); (b), (c) and (d): expression in the blue, green and red filters respectively. (ii) shows an example of a blastocyst which does not express any of the three colours: (a) white light microscope picture of the blastocyst at low power (×10); (b), (c), and (d) show lack of expression of colour in the blue, green and red filters respectively.

FIG. 4 shows DNA uptake in pig ejaculated sperm cells. (A) Time course uptake of end-labeled RSVhDAF plasmid in pig ejaculated sperm cells and nuclear internalization from a selected board. End-labeled RSVhDAF plasmid was incubated with pig ejaculated sperm cells (▴), or pig ejaculated and wash sperm cells (▪) at 17° C. as described in Matherials and Methods. Samples containing about one million sperm were withdrawn at the indicated times and washed thoroughly with SFM. Nuclei were prepared at each time point from ejaculated and washed sperm cells pre-incubated with labeled DNA (●) as described in Matherials and Methods. Determination of uptake (in cpm) at each point of the time course was performing counting 1.106 sperm cells or an equivalent number of isolated nuclei. Cell or nuclear pellets were dissolved in 100 μl 1M NaOH and incubated for 1 h at 37° C., neutralized with 100μ 1M HCl and counted in a scintillation counter. (B) Inhibition of DNA uptake by pig ejaculated and washed sperm cells in the presence of increasing amounts of seminal fluid. Ejaculated and washed sperm cells (1×10⁶/0.2 ml) from pig z were incubated with the indicated volumes of cell-free seminal fluid for 30 min at 17° C. in SFM containing 6 μl BSA; 400 ng of end-labeled RSVhDAF plasmid were subsequently added to each sample for 2 h; sperm cells were then washed and counted as described. (C) Light microscope autoradiography of pig ejaculated sperm cells and nuclei after 2 h incubation with ³H end-labeled RSVhDAF plasmid, Ejaculated and washed sperm cells (panel a) and nuclei (panel b), ejaculated non washed sperm cells (panel c), ejaculated and washed sperm cells pre-incubated with 20 μl of seminal fluid (panel d). After DNA incubation, sperm cells or nuclei were washed, spread on glass slides, and autoradiographed as described. In successful experiments exogenous DNA is bound to the sub-equatorial region of sperm cells and nuclei (panels a and b). H&E stain, 1000× magnification.

FIG. 5 shows time course uptake of end-labeled RSVhDAF plasmid with pig sperm cells from 9 boars. End-labeled RSVhDAF plasmid was incubated at 17° C. with ejaculated and washed sperm cells from the 9 pigs listed in Table 1. Uptake protocol as in FIG. 2.

FIG. 6 shows optimization of DNA uptake. Parallel time course experiments performed at different BSA and DNA concentrations, and temperatures were performed to determine the best DNA incubation conditions for sperm cells from any given donor. In each experiment, one parameter varied, while the remaining two were fixed. Determination of uptake (in cpm) as in FIG. 4. (A) Parallel uptake experiments of end-labeled RSVhDAF plasmid in sperm from boards Z, C, S, V. Each sample contained 10⁶ sperm cells incubated with 400 ng of end-labeled RSVhDAF plasmid at 17° C. for 60 min in SFM plus different amounts of BSA (from 6 to 30 g/l). (B) Parallel time course uptake experiments of end-labeled RSVhDAF plasmid in sperm from boar Z. Sperm cells were resuspended at a concentration of 5×10⁶ cells/ml in SFM containing 6 g/l BSA, mixed with end-labeled RSVhDAF plasmid DNA (2 μg/ml) and incubated at different temperatures. Samples containing 106 sperm were withdrawn at the indicated times, washed and counted as in FIG. 4. (C) Parallel uptake experiments of end-labeled RSVhDAF plasmid in sperm from boards Z, C, S, V, L. For each sample 106 sperm cells in SFM containing 6 g/l BSA were incubated at 17° C. for 60 min with increasing amounts of end-labeled RSVhDAF plasmid. (D) Light microscope autoradiography of ejaculated and washed sperm cells from pig Z overloaded with end-labeled RSVhDAF plasmid.

### DETAILED DESCRIPTION OF THE EMBODIMENTS

A. Media and Compositions

As described above, the inventors have found that the constitution of the medium in which sperm cells are processed during SMGT is important for improving efficiency of SMGT. Typically, the medium comprises, in water, glucose in a concentration of about 56.19 to 68.67 mM, sodium citrate in a concentration of about 30.60 to 37.40 mM, EDTA in a concentration of about 11.37 to 13.89 mM, citric acid in a concentration of about 13.92 to 17.02 mM and Trizma base in a concentration of about 48.31 to 59.05 mM. Typically the medium has an osmolarity of from about 200 to 320 mOs. Typically the medium has a pH of about pH 7.4.

Typically, the concentration of glucose is about 62.43 mM, the concentration of sodium citrate is about 34 mM, the concentration of EDTA is about 12.6 mM, the concentration of citric acid is about 15.7 mM and the concentration of Trizma base is about 53.68 mM.

In one embodiment, the medium has an osmolarity of between 276 to 298 mOs at pH 7.4. Preferably, the medium has an osmolarity of 286 mOs at pH7.4.

The inventors believe that glucose is important for providing a suitable osmolarity for the sperm cells, and for providing an energy source for supporting the viability of the sperm cells. It follow that glucose could be substituted for other sugars capable of providing these functions. An example is fructose. The concentration of fructose required for supporting the viability of sperm cells can be determined using standard techniques known to the skilled addressee.

The inventors also believe that Trizma base (otherwise known tromethamine as 2-amino-2-hydroxymethyl-1,3propanediol), and probably sodium citrate and citric acid, are important for providing a buffering system for supporting a suitable pH for the sperm cells. In this regard, the medium is particularly suited to SMGT protocols that use in vivo artificial insemination. The medium is an advance over in vitro fertilization media such as TALP, because these media use a buffering system that uses carbonate and use of a CO₂ incubator (both of which are used for in vitro fertilization). It follows that one of these components of the medium of the invention could be substituted for another compound capable of providing a buffering system for supporting the desired pH, provided that the compound is not toxic to sperm cells.

The inventors believe that EDTA is important for limiting the capacity of endonucleases to cleave the exogenous nucleic acid molecule to be used a transgene. EDTA affects endonuclease activity by chelating cations, particularly calcium ions, so as to limit the availability of these ions. It is believed that EDTA may be substituted for another compound capable of providing this function, for example a chelator that is not toxic to sperm cells.

Typically, the medium comprises a protein source for the sperm cells, such as bovine serum albumin. Bovine serum is typically in a concentration of 6 g/litre of the medium. The inventors believe that other sources of protein could be used, including, for example, other albumins or serum proteins.

Typically, the water for use in the medium is sterilised and purified sufficient to limit components in the medium that may cause injury to the sperm cells. For example, the water may be double distilled or de-ionised to remove impurities and autoclaved to sterilise the water.

As described above, the invention also provides a process for the production of a medium for supporting the viability of a sperm cell. Typically, the process comprises contacting glucose in an amount of about 10.125 to 12.375 g, sodium citrate (2H₂O) in an amount of about 9.00 to 11.00 g, EDTA (2H₂O) in an amount of about 4.23 to 5.17 g, citric acid (H₂O) in an amount of about 2.925 to 3.575 g, Trizma base in an amount of about 5.85 to 7.15 g, with about 1 litre of water, to form a solution. Typically the solution has a pH of about pH7.4 and an osmolarity ranging from about 200 to 320 mOs.

In one embodiment, glucose is in an amount of about 11.25 g, sodium citrate (2H₂O) is in an amount of about 10 g, EDTA (2H₂O) is in an amount of about 4.7 g, citric acid (H₂O) is in an amount of about 3.25 g, and Trizma base is in an amount of about 6.5 g.

The protein source for the sperm cells may be added after the solution has been formed. Typically the protein source is added in an amount to provide 6 g/litre of protein source. As described above, the protein source is typically bovine serum albumin, however, it is believed that other sources could be used, including other serum albumins.

Where the medium is to be sterilised prior to use, particularly by autoclaving the solution, the protein source is added after sterilisation and prior to use of the medium. This prevents denaturation of the protein source by the sterilising procedure.

The pH of the solution is typically adjusted to provide a pH of about 7.4.

The invention also provides a medium for supporting the viability of a sperm cell, the medium being produced by the above described process.

As described above, the invention also advantageously provides a composition that can be used to provide a medium for supporting the viability of a sperm cell. The composition is preferably provided in a solid form and is adapted to provide the medium of the invention when dissolved in water. The composition comprises glucose, sodium citrate, citric acid EDTA and Trizma base in amounts sufficient for providing an aqueous solution having a concentration of glucose of from about 56.19 to 68.67 mM, a concentration of sodium citrate of from about 30.60 to 37.40 mM, a concentration of EDTA of from about 11.37 to 13.89 mM, a concentration of citric acid of from about 13.92 to 17.02 and a concentration of Trizma base of from about 48.31 to 59.05 mM.

Typically, the composition comprises glucose, sodium citrate, citric acid, EDTA and Trizma base in amounts sufficient for providing an aqueous solution having a concentration of glucose of about 62.43 mM, a concentration of sodium citrate of about 34 mM, a concentration of EDTA of about 12.6 mM, a concentration of citric acid of about 15.7 mM and a concentration of Trizma base of about 53.68 mM.

The composition may additionally contain a protein source for the sperm cells, such as bovine serum albumin in an amount for providing the aqueous solution with a concentration of about 6 g/l of protein source.

In one embodiment, the composition comprises water. 11 this embodiment, the composition is advantageously provided as a concentrate to which water is to be added to provide a medium according to the first aspect of the invention.

B. Collection of a Sample of Sperm Cells

The invention also provides a method for collecting sperm cells from an animal. An advantage of the method is that the sperm cells collected according to the method are optimised for use in SMGT. As described herein, the inventors have found that seminal fluid impinges on the efficiency of SMGT for transgenesis. While factors in seminal fluid have been hypothesised to effect DNA uptake in vitro [Zani et al. 1995 Exp. Cell Res. 217:57-64], the effect of these factors on the efficiency of SMGT for transgenesis was not known prior to this invention.

According to the method, a sample of semen derived from an animal is contacted with a medium according to the invention, to dilute the sample of semen. It is believed that such dilution affects the capacity of factors in the seminal fluid to inhibit uptake of an exogenous nucleic acid molecule for use as a transgene. Accordingly, the frequency of sperm cells transfected with the exogenous nucleic acid molecule is improved.

It is preferable that the sample for collection is one that has been freshly ejaculated. Thus in one embodiment, the sample of semen is a freshly ejaculated sample.

The sample preferably comprises the first fraction of the ejaculated semen that represents about 30 to 40% of the total volume of the ejaculated semen. This sample is believed to contain fewer factors for inhibiting uptake of a nucleic acid molecule. Thus in one embodiment, the sample comprises an initial 30 to 40% of the total volume of the ejaculated semen.

One way of contacting the sample of semen with the medium is to first pour the medium into a vessel and to then collect the sample of semen into the vessel, so that the sample contacts the medium, to dilute the sample of semen in the medium. Thus in one embodiment, the sample of semen is collected into a vessel comprising the medium, to dilute the sample of semen. Alternatively, the sample of semen may be collected into a vessel and the medium subsequently added to the vessel to contact the sample of semen and so dilute it.

The vessel and/or the medium may be pre-warmed to a temperature for supporting the viability of a sperm cell, for example, they may be pre-warmed to about 37° C. This is useful for ensuring that the viability of the sperm cell is supported during collection. Thus in one embodiment, the vessel and/or medium are pre-warmed to a temperature for supporting the viability of a sperm cell, prior to contact of the medium with the sample of semen.

Typically the sample of semen is contacted with more or less an equal volume of medium, to dilute the semen sample. The exact volume of medium is not important, provided that it is sufficient for limiting contact of sperm cells with factors in the seminal fluid that inhibit uptake of a nucleic acid molecule by sperm cells. Thus in one embodiment, the volume of medium contacted with the sample of semen is equal to the volume of the sample of semen.

C. Preparing Sperm Cells for Transfection

The invention comprises a method for preparing sperm cells for transfection, or in other words, for uptake of a nucleic acid molecule. An advantage of the method is that the sperm cells prepared according to the method are optimised for use in SMGT. The method comprises washing a sperm cell in a medium according to the invention, to remove seminal fluid from the sperm cell. Where the sperm cells are to be used for SMGT, it is important to determine the motility of sperm cells in the sample, for example, as described below, because the motility of sperm cells is directly related to a capacity to uptake a nucleic acid molecule.

It is preferred that all seminal fluid is removed from the sperm cells, as this prevents factors in the seminal fluid from inhibiting uptake of the nucleic acid molecule. Accordingly, in one embodiment, all seminal fluid is removed from the sperm cell. It is recognised however, that it is not necessary that all seminal fluid be removed from the sperm cell, as long as the activity of factors in seminal fluid for inhibiting uptake of the nucleic acid molecule by the sperm cell is a least limited.

Typically, the sperm cell is washed according to the following steps:
(a) contacting a sample of semen derived from the animal with a medium according to the first aspect of the invention, to dilute the sample of semen;
(b) isolating sperm cells from the diluted sample;
(c) contacting the isolated sperm cells with a medium according to the first aspect of the invention; and
(d) isolating sperm cells from the medium.

After step (a), the diluted sample of semen may be incubated at room temperature for about 5 minutes, before proceeding to step (b). This step is useful because it provides an opportunity for equilibration and conditioning of the sperm cells in the medium.

It is not important how sperm cells are separated according to step (b), as long as the motility of the sperm cells is maintained. Preferably, the sperm cells are isolated in a first step by centrifugation. Exemplary conditions for centrifugation are about 800 g at about 25° C. for about 10 minutes. As described herein, these conditions limit loss of motility of sperm cells. Other conditions can be determined by the skilled addressee. In a second step, a supernatant that is formed by the sedimentation of sperm cells during the centrifugation is removed by aspiration to complete the isolation process of step (b).

According to step (c), the isolated sperm cells are contacted with a medium according to the first aspect of the invention. Typically, the volume of medium is at least about 500 tines the volume of the pellet. It is preferable that the effect of the contact is to resuspend the sperm cells from the pellet. One way of resuspending cells is to gently flush the pellet with a wide-mouth pipette.

The isolation step of step (d) can be performed as described above in relation to step (b).

Where the sperm cells prepared by the method are to be used for SMGT, it is important to determine the motility of sperm cells in the sample at this stage. Methods for determining motility of sperm cells are described further herein. Further, at least 1×10⁹ sperm cells are required for transfection, so after step (d), it is important that the sperm cells are suspended to a concentration suitable for this purpose.

D. Transfecting Sperm Cells

The invention provides a method for transfecting sperm cells, or in other words, for permitting sperm cells to uptake a nucleic acid molecule. An advantage of the method is that the sperm cells prepared according to the method are optimised for use in SMGT. The method comprises contacting the sperm cell with the nucleic acid molecule in a medium according to the invention.

As seminal fluid contains factors that inhibit uptake of a nucleic acid molecule by a sperm, the sperm cell is washed to remove seminal fluid before contact with the nucleic acid molecule. The method described above for washing a sperm cell is suitable for this purpose. Thus in one embodiment, the sperm cell is free of seminal fluid before contact with the nucleic acid molecule in the medium.

As described herein, the inventors have found that uptake of a nucleic acid molecule is optimised when 90% of the sperm cells bind to the nucleic acid molecule and 70% of these cells internalise the molecule into the nucleus. Further, approximately 20% of sperm bound nucleic acid molecule is internalised into sperm nuclei. Thus in one embodiment, a sample of sperm cells and the nucleic acid molecule are contacted in the medium of the invention in conditions for permitting about 90% of sperm cells in the sample to bind to the nucleic acid molecule. In another embodiment, the sample of sperm cells and the nucleic acid molecule are contacted in the medium of the invention in conditions for permitting about 60% of the sperm cells to which nucleic acid molecule has bound, to internalise the nucleic acid molecule. In another embodiment, a sperm cell and nucleic acid molecule are contacted in the medium in conditions for permitting about 20% of nucleic acid molecule bound to the sperm cell to be internalised into the sperm cell nucleus.

The inventors have found that uptake of a nucleic acid molecule is optimal where sperm cells and nucleic acid molecule are contacted in the following amounts: about 1×10⁹ sperm cells with about 400 ug of nucleic acid molecule. The period of contact is typically about 2 to 4 hours and the temperature is about 17 to 20° C.

The inventors have also found that the uptake of a nucleic acid molecule is optimal where sperm is contacted with a nucleic acid molecule at an early stage of capacitation. Where the sperm cell is prepared according to the methods described above in section C, this means that an ideal time for contact of the nucleic acid molecule with the sperm is within 30 minutes after washing the sperm and no later than 60 minutes after washing the sperm. Methods for monitoring capacitation are described herein.

E. SMGT—Artificial Insemination and In Vitro Fertilisation

SMGT can be performed using in vivo artificial insemination or in vitro fertilisation techniques. These techniques are known to the skilled addressee. Methods for in vivo artificial insemination are described herein, particularly in Standard Operating Procedure, Dept. Of Natural Resources and Environment, Victoria Government, Australia. In vivo artificial insemination techniques for SMGT are also described in [Sperandio et al. 1996 Animal Biotech. 7:58-77].

Methods for in vitro fertilisation are known to the skilled addressee and are described in [Ball et al. 1983 Biol. Reprod. 28:717-725].

F. Producing Animals Comprising 2 or More Trangenes

As described above, the invention also provides a method of producing an animal comprising 2 or more transgenes. An advantage of the method is that many of the intercrosses of particular founders are not required to arrive an “ultimate” animal comprising the desired genotype, so that the “ultimate” animal can be generated with minimal time and expense. The method comprises the following steps:
(a) contacting a sperm cell with 2 or more exogenous nucleic acid molecules, each for use as a transgene, to transfect the sperm cell with each of the 2 or more exogenous nucleic acid molecules;
(b) fertilising an ovum with the transfected sperm cell to permit each of the 2 or more exogenous nucleic acid molecules to be transferred to the ovum; and
(c) maintaining the fertilised ovum in conditions for permitting the fertilised ovum to form the animal.

The method is important because it avoids the need for the intercrosses of particular founders that would otherwise be required to obtain the desired genotype.

The sperm cell may be transfected by contacting the 2 or more exogenous nucleic acid molecules with the sperm cell in the medium of the invention.

While not wanting to be bound by hypothesis, it is believed that physical linkage of the 2 or more exogenous nucleic acid molecules may impinge on the capacity of the method to produce an animal that comprises functional transgenes. That is, a consequence of physical linkage may be rearrangement of the linked nucleic acid molecules which would destroy functionality of the transgene. Accordingly, the 2 or more exogenous nucleic acid molecules are typically provided for transfection as molecules that are not physically linked; in other words, the 2 or more exogenous nucleic acid molecules are each discrete molecular entities.

Typically, in step (a), the two or more exogenous nucleic acid molecules are contacted with the sperm cell to transfect the sperm cell at the same time, or in other words, in the same incubation step. The inventors recognise that in some circumstances, it may be necessary to contact one or more of the two or more nucleic acid molecules with the sperm cell in separate steps. Thus in one embodiment, step (a) comprises contacting one or more of the two or more exogenous nucleic acid molecules with the sperm cell to transfect the sperm cell, and is proceeded by an additional step of contacting the remaining molecules of the two or more exogenous nucleic acid molecules with the sperm cell to transfect the sperm cell.

The sperm cell is contacted with the two or more exogenous nucleic acid molecules in conditions for supporting the viability of the sperm cell. Examples of such conditions are described above in section D, and are described further below in the Examples.

The sperm cells for use in the method may be collected according to the methods described above in section B and may be prepared according to the methods described above in section C.

F. Cells, Tissues and Animals Derived from SMGT

As described above, in a seventh aspect, the invention provides sperm cells transfected according to the method of the invention and in an eighth aspect, to cells tissues and animals prepared by fertilisation of an ovum with said sperm cells.

Also in a further aspect, the invention provides cells, tissues and animals characterised in that they are produced by SMGT and comprise two or more transgenes.

Pigs and porcine cells and tissues are particularly preferred. Examples of suitable pigs are described herein and include Landrace, Large White or Landrace x Large White.

Examples of methods for collecting sperm cells are described above. Methods for collecting other cells and tissues are known to the skilled addressee.

Typically, the cells, tissues and animals are homozygous for the one or more transgenes. Homozygous cells and tissues can be obtained by an intercross of founders that are heterozygous for the transgene.

The following tissues and organs are particularly preferred: liver, heart, thyroid, adrenal, pancreas, pancreatic islets, kidney, bone marrow, lymphocytes, neurons and lungs.

G. Selecting Donors for Providing Sperm Cells

As described above, the invention also provides methods of determining whether sperm cells are optimal for transfection and for use in SMGT. The inventors have found that the quality of sperm is an important consideration for optimisation of the efficiency of SMGT for transgenesis. These methods comprise the step of determining whether at least 65% of sperm cells in a sample are motile.

Also provided are methods for selecting sperm donors, for example boars, that are capable of producing sperm that are optimal for transfection and for use in SMGT. These methods comprises the steps of determining motility of sperm cells in a sample and selecting a sample in which the motility is determined to be at least about 65%.

Typically, the higher % of motile sperm in the sample, the more optimised the sperm in the sample are for transfection and for SMGT. Preferably at least about 75% of sperm in the sample are motile. More preferably, at least about 85% of sperm in the sample are motile.

Typically, the motility of the sperm is determined after the sperm have been prepared according to the method described above in section C. Accordingly, in one embodiment, the method comprises determining whether at least about 65% of sperm cells are motile in the medium of the first aspect. of the invention. However, the inventors believe that the relationship between sperm motility and uptake of a nucleic acid molecule is not dependent on the medium of the invention and accordingly, the motility may be determined when the sperm cells are comprised in another fertilization medium, such as TALP.

As described herein, where the sperm cells are to be used for SMGT, other characteristics of a sperm donor, i.e. characteristics in addition to sperm motility, may be considered. These include the breed and age of the donor and the fertility results of the sperm donor, including conception rate and litter size. These characteristics are described further herein. It will be recognised however, that the characteristic of sperm motility is most important in relation to optimising the efficiency of transfection of sperm cells and for optimising SMGT.

### EXAMPLES

### Example 1

### Preparation of Media

The medium for supporting the viability of a sperm cell (sperm fertilization medium or SFM) was prepared as follows:

a. Reagents
All reagents were obtained from commercial sources as follows:
(D)+Glucose-anhydrous (Sigma Ultra) (Cat # G7528)
Sodium Citrate Trisodium salt: dihydrate (ASC reagent—Sigma) (Cat#S4041)
Ethylenediaminetetractic acid Disodium Salt: dihydrate (Sigma Ultra) (Cat#El644)
Citric acid monohydrate (Sigma Ultra) (Cat#C0706)
Trizma Base (Sigma Ultra) (Cat#T6791)
Bovine Albumin (BSA-Dried)—CSL (Cat#06711701)

b. Preparation of Media

SFM was prepared by forming a solution of 11.25 g (D)+Glucose-anhydrous, 10 g Sodium Citrate Trisodium salt: dihydrate, 4.7 g Ethylenediaminetetractic acid Disodium Salt: dihydrate, 3.25 g Citric acid monohydrate, 6.5 g Trizma Base in 1 litre of distilled autoclaved water. The solution was adjusted to pH7.4 with 1N HCl and autoclaved. The osmolarity of the medium was about 286 mOs. Medium with mOs values between 250-300 or between 276-298 are suitable.

Bovine serum albumin was added to 6 g/L prior to use. The final concentration of BSA was varied for each sperm donor in accordance with optimal DNA binding and uptake as described below.

Where artificial insemination is to be used for mediating gene transfer into an ovum, the SFM was prepared as a fresh solution one day before insemination.

### Example 2

### Collecting a Sample of Sperm Cells from a Mammal

a Animals.

The breeds in this study were Landrace (sperm donors) and Large White or Landrace x Large White (gilts) swine.

All animals were housed and used in compliance with animal care guidelines.

b. Collection of Sperm

Briefly, semen was collected from the donor in a sterile plastic bag placed in a thermostatic container pre-warmed at 37° C., to avoid temperature shock. Quality of semen was evaluated on a slide pre-warmed at 37° C. Only the initial 30-40% of the ejaculate was collected since this fraction contains most of the sperm cells and a low amount of seminal fluid, which may antagonise binding of DNA to sperm cells.

### Example 3

### Preparing a Collected Sample of Sperm Cells for Further Study

After collection of a sample of sperm cells, seminal fluid was subsequently removed by carefully washing the sperm. Briefly, 5 ml aliquots of semen were transferred to 15 ml tubes and mixed with an equal volume of SFM supplemented with 6 mg/ml BSA pre-warmed at 37° C. (from this moment on the medium was kept at room temperature). Semen was incubated for 5 min and then transferred to 50 ml tubes that were filled with SFM/BSA to 50 ml. Samples were spun down at 800 g for 10 min at 25° C. and the supernatants were removed by aspiration without perturbing the pellets, and discarded. The tubes were filled again with SFM/BSA, spun at 800 g for 10 min at 17 C and the supernatants discarded. The sperm cells were carefully resuspended in the residual medium using a wide tip-pipette and the pellets combined in one tube. Sperm cells were counted using a hemocytometric chamber.

### Example 4

### Selecting a Donor for Providing a Sample of Sperm Cells

A sample of sperm cells was collected from each donor once every four to five days on average according to Example 2 and prepared according to Example 3. Donors were selected for providing sperm cells for use in SMGT by assessment of semen quality and DNA binding.

a. Semen Quality

Sperm cells were collected once every four-five days on average, and the semen quality evaluated by assessment of motility. Sperm motility was tested by microscopic inspection of semen on a slide pre-warmed to 37° C. Donors from which motility was observed in at least 80% of the total sperm cells initially collected, and not less than 65% of sperm cells after preparing the collected sample according to Example 3 above, in at least six ejaculates collected over a period of one month, were selected for further study.

Membrane integrity of sperm was measured by means of the hypo-osmotic swelling test [Oosterhuir GJ et al. 1996 J Clin Lab Anal. 10: 209-212].

b. DNA Binding

Sperm cells were prepared as described in Example 3. Following counting, the sperm was re-suspended at 1×10⁷ cells/mL, mixed with linearised, random prime ³H-deoxy-cytidine radio-labelled DNA (0.5 ug/mL) which was 1-3×10⁶ CPM/1 g, and incubated at 18° C. Aliquots of sperm (1×10⁶) were taken at specific times, diluted in Eppendorf tubes containing 1 mL SFM, washed twice by centrifuging at 4000 rpm for 5 minutes and re-suspended in SFM (200 uL).

c. DNA in Nuclei

At the same time as an aliquot was taken for DNA binding analysis, 3×10⁶ sperm were also taken and washed with SFM. Sperm were re-suspended in 26 uL DTT buffer (DTT 100 mM, TRIS 50M, pH 7.5) and incubated on ice for 30 minutes. 1/9 of the volume (ie: 8.6 uL) of CTAB (cetyltrimethylamnonium bromide) buffer (CTAB 10%, DTT 10 mM) was added (1% v/v CTAB final) and incubated ⁴5 minutes on ice. Nuclei were pelleted at 900 rpm for 5′ at room temperature. Pellets are washed with 500 uL of Lysis Buffer (20 mM Tris pH 7.5, EDTA 1 mM, NaCl 10 mM, 1% SDS) by centrifuging (9000 rpm for 5′ at room temperature). Pellets were dissolved in 100 uL 1M NaOH for at least 1 hour at 37° C. and neutralised with an equal volume of 1M HCl.

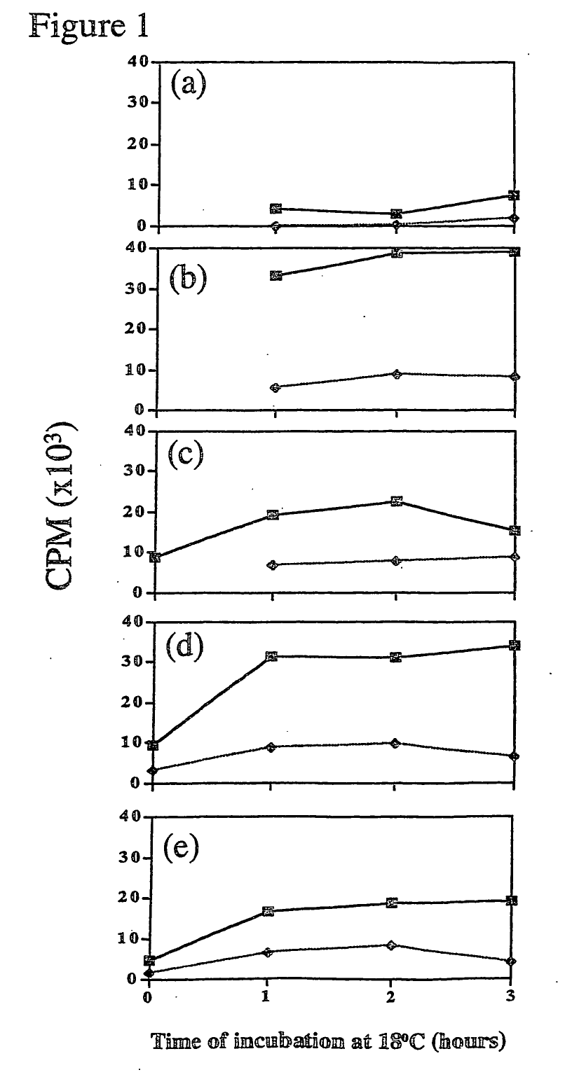

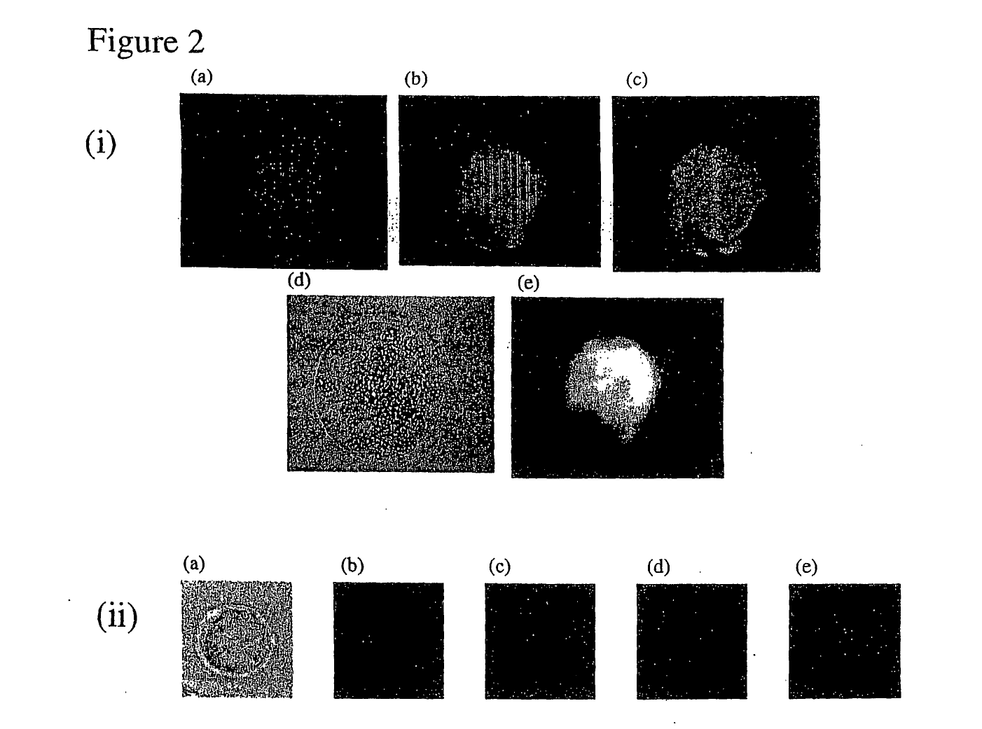

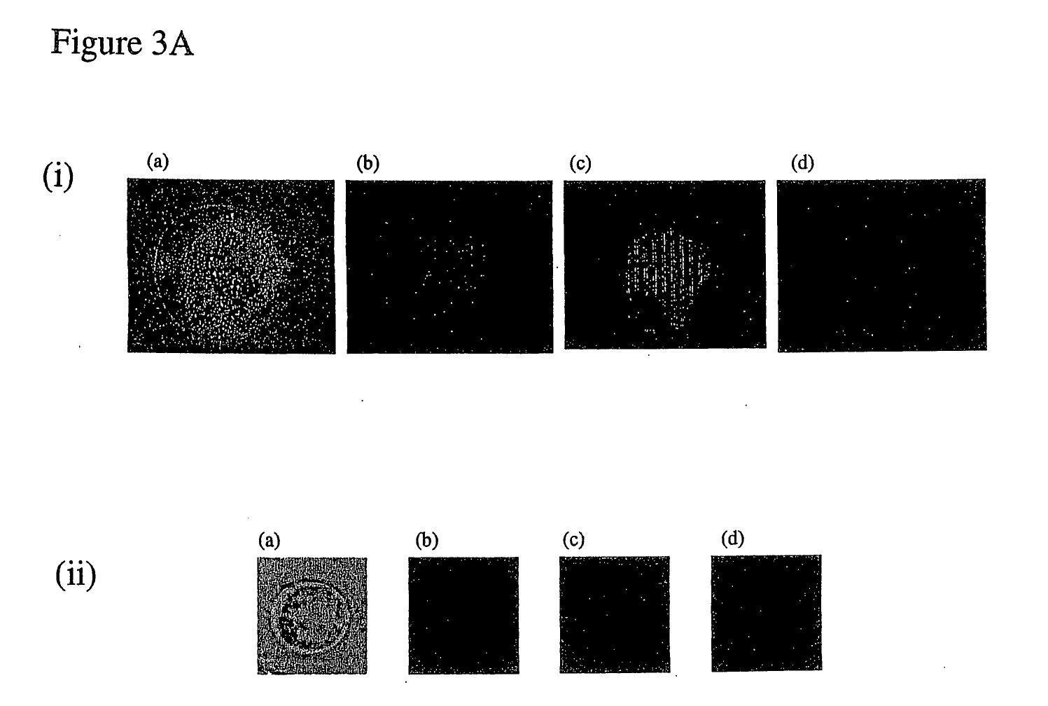

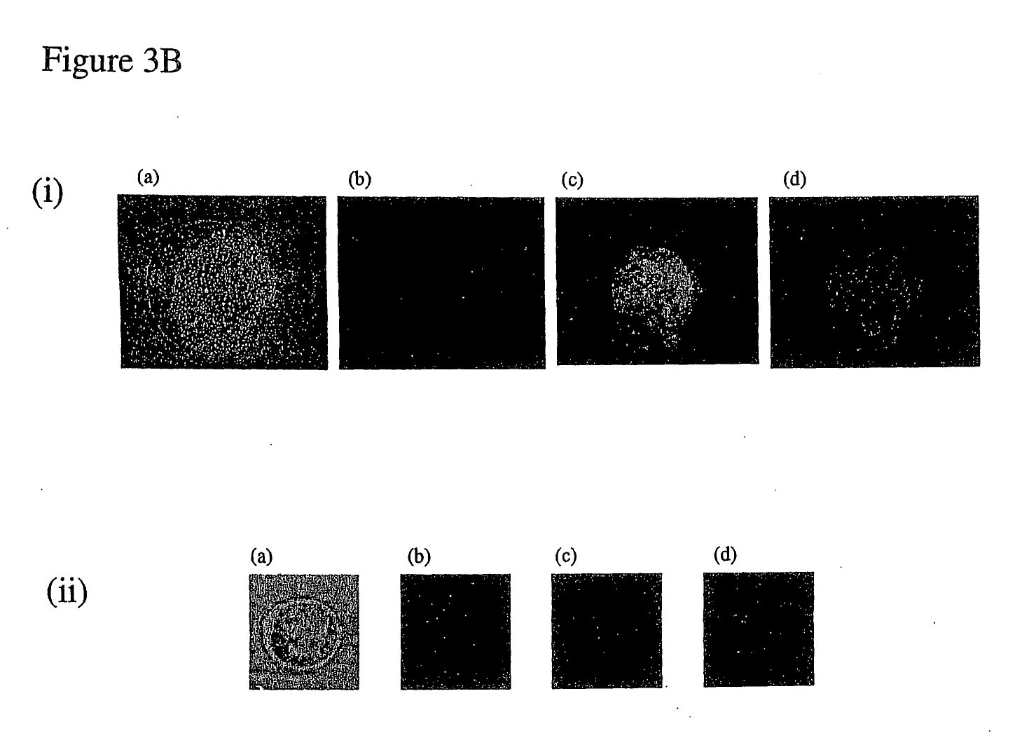

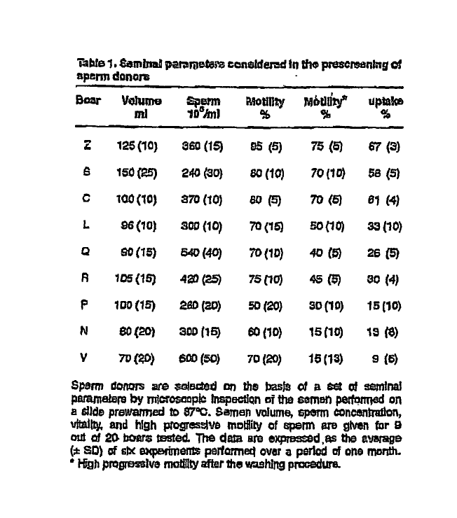

Radioactivity of samples was determined by liquid scintillation counts in 5 mL Packard Ultima Gold scintillation cocktail (Cat # 6013329). FIG. 1 shows uptake of ³H-deoxy-cytidine radiolabelled linear EBFP plasmid DNA by pig sperm from 5 boars (a-e).

Autoradiography was also performed to verify that exogenous DNA were taken up by the majority of the sperm cells and nuclei, and that DNA were correctly localized within the sperms. Aliquots of ³H-radiolabelled sperm cells were washed and treated according to Lavitrano et al. 1992 Mol. Reprod. Dev. 31: 161-169.

d. Sperm Capacitation

This was monitored by observing changes in motility and by using the chlorotetracycline fluorescence assay as described in Ward and Storey Dev Biol 1984 104: 287-296, and Barboni 1994 Zygote 2: 367-369.

### Example 5

### Methods of Transfecting Sperm Cells—Uptake and Expression of Multiple Genes

Semen was collected from a transgenic CD46 boar according to Example 2 and prepared as described in Example 3.

10⁹ viable sperm was diluted to 120 mL with 18° C. pre-equilibrated SFM/BSA 400 ug of DNA was added per 106 sperm cells. DNA consisted of equal parts EBFP (enhanced blue fluorescent protein), EBFP, (enhanced green fluorescent protein) and dsRed2 plasmid DNA which had been linearised with EcoRI. The sperm and DNA were incubated at 18° C. for 2 hour (optimal uptake time for the sperm from the boar used) with the flask gently inverted every 15-20 minutes.

### Example 6

### Methods of SMGT—Artificial Insemination

Sperm cells were transfected with a transgene according to Example 5, however in the final 20 minutes, the incubation was performed at room temperate and then 37° C. for the final minute before insemination.

A cycling sow was artificially inseminated using an inseminating pipette and loading the incubate directly into the uterus according to standard procedures (eg Standard Operating Procedure, Dept. Of Natural Resources and Environment, Victoria Government, Australia.

The sow was sacrificed at day 6 and embryos (predominantly late morula, early blastocyst stage) were harvested by flushing each uterine horn with 30 mL Embryo Flushing Media (Dulbecco's phosphate buffer saline (PBS⁺) with 0.4% BSA w/v, 0.34 mM pyruvate and 5.5 mM glucose) at 36° C. Recovered embryos were examined by UV microscopy (Leica DMR) for expression of the fluorescent DNA.

More specifically, the Living Colours Fluorescent Proteins have excitation maxima/emission maxima of 380 nm/440 nm, 488 nm/507 nm and 558 nm/583 nm for EBFP, EGFP and dsRed2 respectively. The Lw microscope has a green filter (Leica L9) which has an excitation of 450-490 nm and emission of 515-560 nm (bandpass) with dicot. mirror at 510. The red filter (Leica N2.1) has an excitition of 515-560 nm and emission of 580 nm (longpass) with a dicot. mirror of 480. The blue filter (Leica A4) has an excitation of 360 nm peak with a ½ band of 40 (ie: 360\40 nm) and emission of 470\40 nm with a dicot. mirror at 400. These filters have been shown to be specific for detection of each fluorescent protein by the transfection of the CHOP cell line with each of the fluorescent proteins. Cells transfected with EBFP can only be detected in the blue filter, cells transfected with EGFP can only be detected with the green filter and cells transfected with dsRed2 can only be detected with the red filter. The bleed through of green fluorescence into the red filter and red fluorescence into the green filter is negligable/absent using these filters on the UV microscope, as opposed to the FACS were there is leakage in the green and red channels requiring compensations to be set.

The presence of exogenous or transferred DNA in embryos was also detected by PCR, screening both the nucleotide sequence and the promoter using two sets of primer pairs. Transgene expression was also examined by Western blots. Screening of offspring is undertaken using PCR and Southern blot analysis of DNA extracted from ear and tail tissues after cleaning to remove potential contaminants.

### Example 7

### Production of Transgenic Embryos by SMGT

All 91 embryo's generated by fertilisation of eggs with semen which had taken up EBFP, EGFP and dsRed2 exogenous DNA expressed all three colours of fluorescence proteins (blue, green and red).

In a preliminary experiment using only EGFP DNA, all 7 fertilised embryos that were recovered expressed green fluorescent protein.

Control embryos which are fertilised with semen that has not been incubated with exogenous DNA encoding for the fluorescence proteins do not express any fluorescence and serve as the negative control.

Maternal blood was taken from a CD46 sow at Day 98 following insemination. This sow had been inseminated with sperm from a CD46 boar which had taken up EBFP, EGEP and dsRed2 DNA and had been shown to be pregnant by oesterone sulphate assay of a Day 26 bleed (the standard way of detecting pregnancy).

The PBMC fraction from the day 98 bleed contained cells and cell debris which expressed all three colours of fluorescence. This suggests that at least one foetus of the pregnant sow expresses all three fluorescence genes.

### Example 8

### Analysis of Optimised SMGT Efficiency

Materials and Methods

a Animals

The breeds in this study were Landrace (sperm donors) and Large White or Landrace x Large White (gilts) swine. Artificial inseminations were performed using DNA loaded sperm, prepared as described below, from selected boars kept trained and not exposed to natural mating. Prepubertal gilts (animals that had never given birth), weighing 70-80 kg, were synchronised by injecting 1250 IU of ECG (Folligon, Intervet, Holland) and 60 h later 750 IU of hCG (Corulon, Intervet, Holland). Ovulation occured 40 h after hCG injection. Artificial inseminations were performed 43 h after hCG injection using 1-1.5×10⁹ DNA treated sperm cells/gilt. Artificial insemination was then carried out with an inseminating pipette according to standard procedures.

All animals were housed and used in compliance with animal care guidelines.

b. Preparation of Sperm, DNA Uptake and Artificial Insemination

Samples of sperm cells were collected according to Example 2 and prepared according to Example 3 above.

10⁹ sperm cells were incubated with 400 μg plasmid DNA at 17° C. in SFM/BSA for 2 h. Artificial insemination is carried out using an inseminating pipette according to standard procedures.

c. Assessment of DNA Uptake.

Scintillation counting was performed on ejaculated or ejaculated and washed sperm cells resuspended at a concentration of 5.10⁶ cells/ml in SFM, containing 6 g/l BSA, mixed with ³H end-labelled RSVhDAF plasmid DAN (2 μg/ml) and incubated at 17° C., all unless specified differently. Aliquots containing 1.×10⁶ sperm cells were withdrawn from the incubation mixture at specific times, diluted in Eppendorf tubes, containing 1 ml of SFM and washed twice by centrifuging at 4000 rpm for 5 min in a microfuge. In order to prepare nuclei, aliquots containing at least 3.10⁶ sperm cells were withdrawn at the same time points and thoroughly washed with SFM. Nuclei were prepared, briefly, as follows: sperm cells were suspended in DTT buffer (DTT 100 mM, Tris 50 mM pH 7.5) at the concentration of 1×10⁶ sperm cells/26 μl and incubated for 30 min on ice; CTAB (Cetyltrimethylammonium bromide, Sigma Aldrich, St. Louis, Mo.) solution (CTAB 10%, DTT 10 mM) is added at 1/9 the volume (1% CTAB final) and further incubated for 45-60 min on ice. Nuclei were pelleted at 9000 rpm in a microfuge for 5 min at room temperature and pellets are washed with 500 μl of 50 mM Tris pH 8.0 by centrifuging as above. Sperm or nuclear pellets were dissolved in 100 μl of 1 M NaOH for at 14 est 1 h at 37° C., neutralized with an equal volume of 1 M HCl, and counted. For autoradiography, aliquots of sperm cells were incubated with ³H-end-labeled plasmid with a specific activity of 1×10⁶ cpm/1 g, washed and treated. For both types of assays, scintillation counting and autoradiography, DNA end-labeling is carried out by filling in the 5′ protruding ends of the linearized plasmid using the Klenow subunit of DNA polymerase I.

d. Preparation of Seminal Fluid and DNA Uptake Inhibition

Seminal fluid was prepared by centrifugation of pig semen. Sperm cells were sedimented at 700 g for 10 mins. Supernatants were further centrifuged for 1 min at 12000 g in a microfuge. Increasing amounts of seminal fluid were mixed with ejaculated washed sperm cells in a volume of 200 μl containing 1×10⁶ sperm cells and incubated for 30 min at 17° C. Labeled DNA (400 ng/200 μl) was then added for an additional 60 min. Washing, counting and autoradiography were as described above.

Results

a. Technical Aspects of the SMGT Method in Pigs

We have established the parameters that optimise efficiency of SMGT. We used as test gene of interest a minigene for human decay accelerating factor (hDAF), expression of which has been shown to help prolong survival of pig organs in non-human primates.

b. Selection of Appropriate Sperm Donors and Optimization of Sperm/DNA Interaction are the Key Steps for Successful SMGT

Choice of a good sperm donor requires significant effort, however, once a boar is chosen, that boar can be used for years, infact sperm cells from a given boar show highly reproducible characteristics over time.

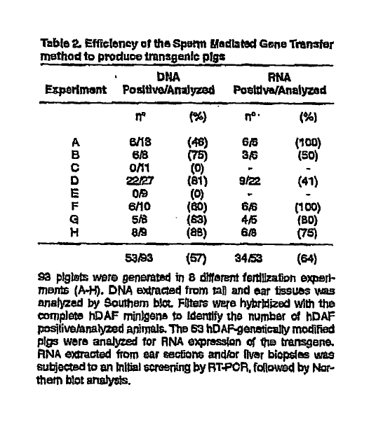

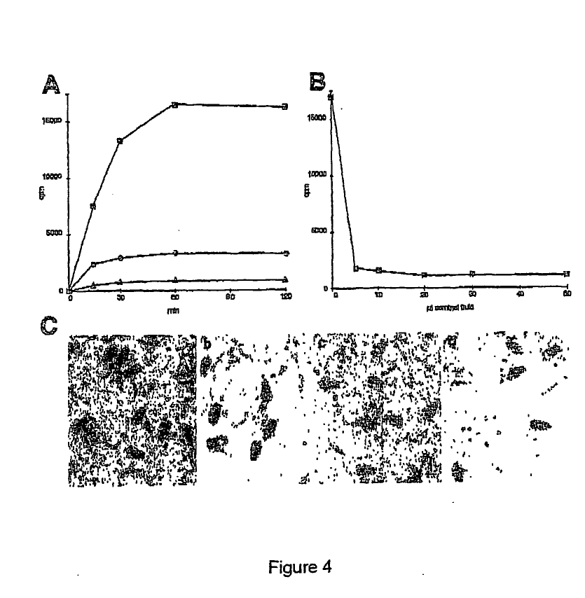

Selection of sperm donors requires evaluating (i) the quality of semen based on standard parameters used in conventional animal breeding programs and (ii) the ability of the sperm cells to take up and internalize exogenous DNA (FIG. 4).

Sperm quality is influenced by many factors, such as the season of the year (semen quality declines significantly during the hot season), collection frequency, breed and age of the donor. The breed used in this study was Landrace (3-4 year old boars), because the semen quality is better than in Large White or Duroc. Sperm collection in our study was no more frequent than every four days; the boars normally ejaculated every four to five days. Sperm quality was evaluated by fertility results (conception rate and litter size) obtained at breeding farms [Holt et al. 1997 J. Androl. 18:312-323]. In addition, we paid particular attention to high progressive motility of sperm. To test motility, microscopic inspection of the semen was performed on a slide prewarmed to 37° C. Table 1 shows the results for 9 of the 20 boards tested. Motility should be at least 85% initially, and not less than 65% after the washing procedure, on at least six different ejaculates collected over a period of one month. Membrane integrity of the sperm cells is documented by means of the hypo-osmotic swelling test [Austin 1952 Nature 170:326; Oosterhuis et al. 1996 J. Clin. Lab. Anal. 10:209-212].

A critical parameter in sperm selection is the ability of sperm cells to bind exogenous DNA and internalize it into their nuclei. DNA uptake correlates with semen quality, particularly in terms of “high progressive motility” of the sperm after ejaculation. DNA uptake is assessed by two techniques. The amount of labelled exogenous DNA bound to sperm cells or nuclei is determined by scintillation counting in time course experiments. Autoradiographic experiments are also performed for each time point to verify that the exogenous DNA is correctly localized within sperm cells or nuclei (see Materials and Methods). FIG. 4A shows a time course of uptake of end-labeled RSVhDAF plasmid by ejaculated pig sperm cells and its internalization into nuclei. We found that untreated ejaculated pig spermatozoa do not take up exogenous DNA (FIG. 4A, ▴); DNA uptake takes place only after extensive washing of the sperm and “complete” removal of seminal fluid as shown in FIG. 4A (▪). Approximately 20% of the DNA bound to the sperm is internalized into the sperm nuclei (“FIG. 4A, ●). Autoradiographic analysis of ejaculated-washed sperm cells incubated for 2 h with DNA shows that the binding occurs on the sub-acrosomal region of the sperm head and sperm nuclei (FIG. 4, panel C a and b). In the non-washed ejaculated sperm cells there is essentially no binding of exogenous DNA (FIG. 4, panel Cc). Furthermore, small amounts of seminal fluid added to thoroughly washed sperm prevents DNA uptake (FIG. 4, panels B and Cd).

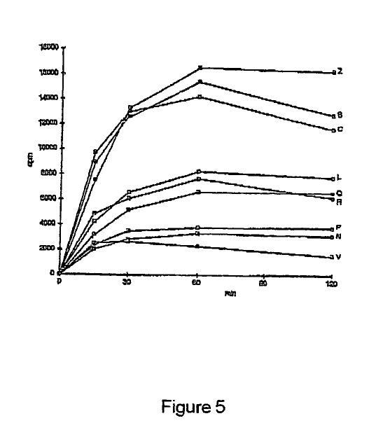

A number of donors chosen on the basis of semen quality were screened for DNA uptake. FIG. 5 shows a time course of DNA uptake by sperm cells from the 9 boars described in Table 1. Sperm cells from the 9 boars reproducibly differ greatly in their capacity to take up exogenous DNA, although the kinetics of uptake is similar. In all cases there is rapid binding of most of the DNA during the initial 15-30 min followed after 60 min by a plateau. DNA uptake correlates with semen quality, particularly in terms of high progressive motility (Table 1). Two boars, Z and S, were selected and used in the SMGT expeliments. The boars that were chosen are thus the ones that took up comparatively high amounts of DNA, with the DNA contained in most of the sperm and properly localized.

c. Optimization of DNA Uptake

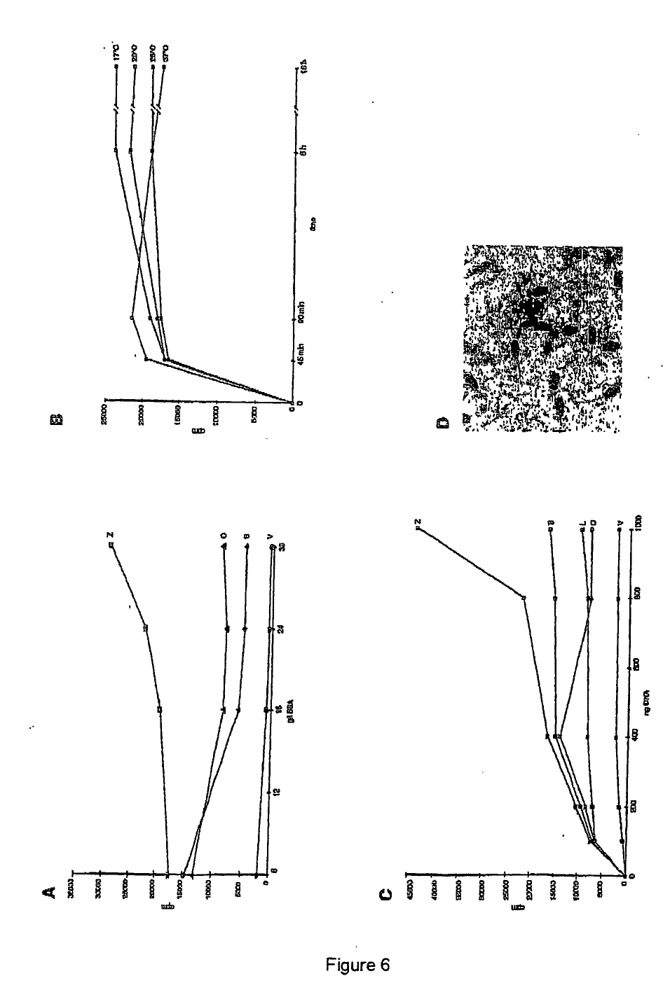

In acceptable experiments, exogenous DNA binds to about 90% of the sperm cells and binding is followed by nuclear internalization in 70% of those cells. (FIG. 6 Panels A and C). We found: in general that approximately 20% of the sperm-bound DNA is internalized into sperm nuclei. Nuclear internalization is completed within 60 min (FIG. 4 panels A and C b). To optimize the protocol for generating transgenic animals, it is necessary to establish when, for how long and in what quantity DNA must be added to sperm. These parameters, discussed below, were assessed by loading washed sperm cells and end-labeled DNA at various times after collection, and assessing DNA uptake.

d. When is the Best Time for Initiating Sperm-DNA Interaction?

There is a window of opportunity that coincides with the early stage of capacitation. DNA is ideally added within 30 min after washing the sperm and not later than 60 min. Capacitation is the time during which a number of physiological changes take place that make sperm competent to fertilize (Austin 1952). Capacitation was monitored by observing changes in motility and by carrying out the chlortetracycline (CTC) fluorescence (Ward et al. 1984; Barboni 1994). Chlortetracycline staining allows for a rapid evaluation of sperm capacitation, showing different fluorescent patterns according to the different functional status of sperm. Capacitation time should be modulated (see below) so as to allow for complete interaction between the sperm and the DNA.

e. How Long Should Sperm be Incubated with Exogenous DNA?

Acceptable sperm donors should be able to complete DNA-sperm interaction within 2 to 4 h, during which time capacitation must be allowed to proceed at its normal pace, avoiding acceleration of the process. The presence of calcium in the medium promotes the likelihood that endogenous endonucleases will cleave exogenous DNA, potentially leading to integration of rearranged DNA and triggering of apoptotic events in the sperm genome. We thus developed a calcium-free medium. Using this calcium-free medium, which slows down capacitation time after removal of seminal fluid, we varied the temperature and the amount of BSA added to the medium, which modulate capacitation time. We have carried out a number of time course experiments aimed at optimizing the uptake process in the absence of calcium. Parallel time course experiments at different temperatures (17° C., 20° C., 25° C., 37° C.) or BSA concentrations (from 6 to 30 g/l) were performed to determine the best DNA incubation conditions for sperm cells from any given donor (FIGS. 6A and B). Such experiments must be carried out on the sperm of each selected boar. In the experiments reported in FIG. 6A, varying amounts of BSA were added to the calcium-free medium. Sperm preparations from boars Z, S and C are all acceptable, based on their responses to the different concentrations of BSA, however, S and C are best if incubated with 6 μl, whereas Z appears to perform better by this assay when incubated with at 30 μl. However, at the highest concentration of BSA, the DNA did not localize correctly in the sperm of Z, i.e., the sperm were overloaded with DNA, as shown by autoradiographic studies (FIG. 6D). Thus for Z as well we used 6 μl BSA in SFM. Sperm from boar V was rejected, given the very low uptake, which is also evidenced by the results of autoradiography.

f. At What Temperature Should the DNA be Added to the Sperm?

In general, we found that incubation at 17° C. to 20° C. was best for DNA uptake; at this temperature there is diminished nuclease activity as compared to higher temperatures and decreased motility, thus energy is conserved for artificial insemination (FIG. 6B).

g. How Much DNA Should be Added?

It is important to optimize the amount of exogenous DNA per sperm cell, so as to obtain the highest number of sperm containing DNA without overloading (FIG. 6D). DNA-overloaded sperms could be damaged or disadvantaged in fertilization compared with normal spermatozoa, and artificial insemination could amplify the disadvantage. An important parameter in this aspect of testing is whether sperm is resistant to increasing concentrations of DNA, i.e., whether overloading will lead to decreased uptake. Sperm from boar Z again performs best by this assay. Whereas C and S both seemed acceptable when testing concentrations of BSA added, the valuation of added DNA showed that S was resistant to higher concentrations (the uptake did not decrease), while C was not (uptake decreased with DNA concentrations above 400 ng/1×10⁶ sperm). Thus, S was chosen as a sperm donor while C was not (FIG. 6C).

h. Using the SMGT Method: Production of Transgenic Pigs by Sperm Mediated Gene Transfer

Sperm cells from two selected boars (Z and S) were used as vectors for transferring into eggs by artificial insemination a 6.8 kb construct containing a hDAF minigene. Fifteen gilts were fertilized in eight experiments over a period of eighteen months. 93 piglets were generated. Table 1 summarises DNA and RNA studies based on PCR, Southern blot, RT-PCR and Northern blot analyses. Southern blots were performed on DNA extracted from tail and ear tissue biopsies collected at birth, Northern blots and RT-PCR on RNA samples from ear, liver or muscle biopsies from pits positive for DNA. DNA of 53 of the 93 animals (57%) contained hDAF sequences. The HDAR transgene was transcribed in all tissues tested in 34/53 (64%) of the animals. The expressed gene product was stably transmitted to progeny, found in caveolae as it is in human cells, and functional in several assays.

1. A medium for supporting the viability of a sperm cell comprising, in water, glucose in a concentration of about 56 to 69 mM, sodium citrate in a concentration of about 31 to 37 mM, EDTA in a concentration of about 11 to 14 mM, citric acid in a concentration of about 14 to 17 mM and Trizma base in a concentration of about 48 to 59 mM, wherein the medium has an osmolarity of from about 200 to 320 mOs and a pH of about pH 7.4.

2. A medium according to claim 1 wherein the concentration of glucose is from about 56.19 to 68.67 mM, the concentration of sodium citrate is from about 30.60 to 37.40 mM, the concentration of EDTA is from about 11.37 to 13.89 mM, the concentration of citric acid is from about 13.92 to 17.02 mM and the concentration of Trizma base is from about 48.31 to 59.05 mM.

3. A medium according to claim 2 wherein the concentration of glucose is about 62.43 mM, the concentration of sodium citrate is about 34 mM, the concentration of EDTA is about 12.6 mM, the concentration of citric acid is about 15.7 mM and the concentration of Trizma base is about 53.68 mM.

4. A medium according to claim 1 wherein the medium has an osmolarity of between 276 to 298 mOs at pH 7.4.

5. A medium according to claim 4 wherein the medium has an osmolarity of 286 mOs at pH7.4.

6. A medium according to claim 1, further comprising 6 g/liter of bovine serum albumin.

7. A process for the production of a medium for supporting the viability of a sperm cell comprising contacting glucose in an amount of about 10.1 to 12.4 g, sodium citrate (2H₂O) in an amount of about 9.0 to 11.0 g, EDTA (2H₂O) in an amount of about 4.2 to 5.2 g, citric acid (H₂O) in an amount of about 2.9 to 3.6 g and Trizma base in an amount of about 5.9 to 7.2 g, with about 1 liter of water, to form a solution with a pH of about pH7.4 and an osmolarity ranging from about 200 to 320 mOs.

8. A process according to claim 7 wherein the amount of glucose is from about 10.125 to 12.375 g, the amount of sodium citrate (2H₂O) is from about 9.00 to 11.00 g, the amount of EDTA (2H₂O) is from about 4.23 to 5.17 g, the amount of citric acid (H₂O) is from about 2.925 to 3.575 g, the amount of Trizma base is from about 5.85 to 7.15 g.

9. A process according to claim 8 wherein glucose is in an amount of about 11.25 g, sodium citrate (2H₂O) is in an amount of about 109, EDTA (2H₂O) is in an amount of about 4.7 g, citric acid (H₂O) is in an amount of about 3.25 g, and Trizma base is in an amount of about 6.5 g.

10. A process according to claim 7 wherein the pH of the solution is adjusted to provide a pH of about 7.4.

11. A process according to claim 7, further comprising contacting the solution with 6 g bovine serum albumin per liter of solution.

12. A medium for supporting the viability of a sperm cell, the medium being produced by the process according to claim 7.

13. A composition for providing a medium for supporting the viability of a sperm cell comprising glucose, sodium citrate, citric acid, EDTA and Trizma base in amounts sufficient for providing an aqueous solution having a concentration of glucose of from about 56 to 69 mM, a concentration of sodium citrate of from about 31 to 37 mM, a concentration of EDTA of from about 11 to 14 mM, a concentration of citric acid of from about 14 to 17 mM and a concentration of Trizma base of from about 48 to 59 mM.

14. A composition according to claim 13 wherein glucose, sodium citrate, citric acid, EDTA and Trizma base are in amounts sufficient for providing an aqueous solution having a concentration of glucose of from about 56.19 to 68.67 mM, a concentration of sodium citrate of from about 60 to 37.40 mM, a concentration of EDTA of from about 11.37 to 13.89 mM, a concentration of citric acid of from about 13.92 to 17.02 mM and a concentration of Trizma base of from about 48.31 to 59.05 mM.

15. A composition according to claim 14 wherein glucose, sodium citrate, citric acid, EDTA and Trizma base are comprised in amounts sufficient for providing an aqueous solution having a concentration of glucose of about 62.43 mM, a concentration of sodium citrate of about 34 mM, a concentration of EDTA of about 12.6 mM, a concentration of citric acid of about 15.7 mM and a concentration of Trizma base of about 53.68 mM.

16. A composition according to claim 13 further comprising bovine serum albumin in an amount for providing an aqueous solution with a concentration of about 6 g/l of bovine serum albumin.

17. A composition according to claim 13 wherein the composition comprises water.

18. A method for collecting sperm cells from an animal for use in sperm-mediated gene transfer comprising contacting a semen sample derived from the animal with a medium according to claim 1, to dilute the sample of semen.

19. A method according to claim 18 wherein the sample of semen is a freshly ejaculated sample.

20. A method according to claim 19 wherein the sample comprises an initial 30 to 40% of the total volume of the ejaculated semen.

21. A method according to claim 18 wherein the sample of semen is collected into a vessel comprising the medium, to dilute the sample of semen.

22. A method according to claim 21 wherein at least one of the vessel and/or medium are pre-warmed to a temperature for supporting the viability of a sperm cell, prior to contact of the medium with the sample of semen.

23. A method according to claim 18 wherein a volume of medium contacted with the sample of semen is equal to the volume of the sample of semen.

24. A method for preparing a sperm cell for use in sperm-mediated gene transfer comprising washing a sperm cell in a medium according to claim 1, to remove seminal fluid from the sperm cell.

25. A method according to claim 24 wherein all seminal fluid is removed from the sperm cell.

26. A method according to claim 24 wherein the sperm cell is washed according to the following steps:
(a) contacting a sample of semen derived from the animal with a medium according to claim 1, to dilute the sample of semen;
(b) isolating sperm cells from the diluted sample;
(c) contacting the isolated sperm cells with a medium according to claim 1; and
(d) isolating sperm cells from the medium.

27. A method for transfecting a sperm cell with a nucleic acid molecule comprising contacting the sperm cell with the nucleic acid molecule in a medium according to claim 1.

28. A method according to claim 27 wherein the sperm cell and nucleic acid molecule are contacted in the medium in conditions for permitting about 90% of the sperm cells to bind to the nucleic acid molecule.

29. A method according to claim 28 wherein the sperm cell and nucleic acid molecule are contacted in the medium in conditions for permitting about 60% of the sperm cells to which nucleic acid molecule is bound to internalized the nucleic acid molecule.

30. A method according to claim 27 wherein the sperm cell and nucleic acid molecule are contacted in the medium in conditions for permitting about 20% of nucleic acid molecule bound to a sperm cell to be internalized into the sperm cell nucleus.

31. A method according to claim 27 wherein about 1×109 sperm cells are contacted with about 400 ug of nucleic acid molecule.

32. A method according to claim 27 wherein the sperm cell and nucleic acid molecule are contacted in the medium for about 2 to 4 hours at about 17 to 20° C.

33. A sperm cell transfected according to the method of claim 27.

34. A cell prepared by fertilization of an ovum with a sperm according to claim 33.

35. A method for determining whether a sample of sperm cells is optimal for transfection comprising determining whether at least about 65% of the sperm cells in the sample are motile.

36. A method for selecting a sample of sperm cells for transfection comprising:
(a) determining the motility of sperm cells in a sample; and
(b) selecting a sample in which the motility of sperm cells is determined to be at least about 65%.

37. A method for determining whether a sample of sperm cells are optimal for introducing a transgene into an oocyte comprising determining whether at least about 65% of sperm cells in the sample are motile.

38. A method for selecting a sample of sperm cells that are optimized for introducing a transgene into an oocyte comprising:
(a) determining the motility of sperm cells in a sample; and
(b) selecting a sample in which the motility of sperm cells is determined to be at least about 65%.

39. A method of producing an animal comprising at least 2 transgenes comprising:
(a) contacting a sperm cell with at least 2 exogenous nucleic acid molecules, each for use as a transgene, to transfect the sperm cell with each of the at least 2 exogenous nucleic acid molecules;
(b) fertilizing an ovum with the transfected sperm cell to permit each of the at least 2 exogenous nucleic acid molecules to be transferred to the ovum; and
(c) maintaining the fertilized ovum in conditions for permitting the fertilized ovum to form the animal.

40. A non-human animal produced by the method of claim 39.
